(19) United States
(12) Patent Application Publication
(10) Pub. No.: US 2026/0208860 A1
(43) Pub. Date: Jul. 23, 2026

(54) VTOL-AIRCRAFT

(71) Applicant: Jürg WETTSTEIN, Pfäffikon (CH)

(72) Inventor: Jürg WETTSTEIN, Pfäffikon (CH)

(21) Appl. No.: 19/158,201

(22) PCT Filed: Feb. 16, 2024
(86) PCT No.: PCT/EP2024/054035

§ 371 Date: Aug. 20, 2025

(30) Foreign Application Priority Data
Feb. 20, 2023 (EP) 23157602.6

(51) Int. Cl. B64C 29/00

(52) U.S. Cl. CPC B64C 29/0033

(57) ABSTRACT

The invention relates to a VTOL aircraft comprising (a) a cruising flight system comprising at least one wing, wherein the wing is configured to generate dynamic lift during cruising flight, (b) a hover flight system comprising at least one lift element and at least one stabilizing element, wherein (i) the lift element is configured to provide a lift force for hover flight, and (ii) the stabilizing element is configured to provide, using a particular lever, at least one stabilizing force relative to a longitudinal axis, to a transverse axis and/or to a vertical axis of the VTOL aircraft during hover flight and during a transition from hover flight to cruising flight and during a transition from cruising flight to hover flight.

### TECHNICAL FIELD

The present invention relates to a VTOL aircraft, i.e., a vertical take-off and landing aircraft (the English acronym VTOL stands for Vertical Take-Off and Landing), or in other words, an aircraft capable of vertical take-off and vertical landing.

A typical VTOL aircraft is equipped with a wing for mainly horizontal cruising flight and uses hovering mainly only for vertical take-off and vertical landing. It is of course also possible to take off and land horizontally. The VTOL aircraft according to the invention can be manned or unmanned.

### STATE OF THE ART

Winged aircraft enable an efficient horizontal cruising flight because they utilize the dynamic lift that is facilitated by the airfoils. However, these aircraft require a lot of space for take-off and landing, as well as a certain air corridor for arrival and departure.

Gyrocopters, in particular helicopters or multicopters, on the other hand, are extremely precise and flexible during take-off and landing, but require comparatively a lot of energy for a cruising flight. This means that gyrocopters cannot achieve long ranges or high speeds.

There are numerous concepts for combining vertical take-off and landing characteristics with the advantages of pure fixed-wing aircraft. Such combination systems are more complex and therefore have inherent disadvantages compared to pure fixed-wing aircraft.

The state of the art includes a wide variety of concepts.

Swing-wing aircraft, for example, tilt the wing with the engines by approximately 90 degrees.

Swing drives only tilt the individual engines attached to the aircraft (wing/fuselage/tail) by approximately 90 degrees.

Other systems work with booms on the fuselage side and/or on the wings, for example in order to combine four lift points with a fixed-wing aircraft, similar to a quadcopter.

However, such booms and/or propellers, which are suspended in cruising flight, cause considerable air resistance and the unfavorable distribution of masses far away from the center of gravity results in undesirable inertia of the overall system, wherein the booms can also be susceptible to vibrations and/or oscillations.

The requirements for thrust drive units for developing a high thrust for hover flight and for developing high cruising speeds are also considerably different. Swing drives that are designed to operate optimally in both hover flight and cruising flight therefore often require an adjustment mechanism (e.g., variable pitch, variable cross-section of the thrust nozzle, etc.), which in turn increases complexity, maintenance costs, and the risk of failure.

### Object of the Invention

Fixed-wing aircraft having the ability to take off and land vertically must therefore be optimized such that as little additional mass as possible is added, the mass distribution of the overall system is not unfavorable, air resistance during cruising flight is low, the system and/or mechanics are simple and fail-safe and/or redundant, stable hovering/maneuvering is possible, sufficient space is available and sufficient carrying capacity for payload is provided.

Therefore, it is an object of the invention to provide an improved VTOL aircraft. The solution of the object is defined by the features of claim 1.

### DESCRIPTION OF THE INVENTION

The present invention relates to a VTOL aircraft comprising (a) a cruising flight system comprising at least one wing, wherein the wing is configured to generate dynamic lift during cruising flight, (b) a hover flight system comprising at least one lift element and at least one stabilizing element, wherein (i) the lift element is configured to provide a lift force for hover flight, and (ii) the stabilizing element is configured to provide, using a particular lever, at least one stabilizing force relative to a longitudinal axis, to a transverse axis and/or to a vertical axis of the VTOL aircraft during hover flight and during a transition from hover flight to cruising flight and during a transition from cruising flight to hover flight.

In particular, the lift element and stabilizing element are separate elements. This means that two elements, which are distinct from each other, are in point of fact provided by the lift element and stabilizing element.

In particular, the lift element is not designed for stabilization and the stabilizing element is not designed for lift.

In particular, the lift element is configured only to provide the lift force for hover flight and the stabilizing element is configured only to provide the stabilizing force.

In particular, the phrase “relative to a longitudinal axis, to a transverse axis, and/or to a vertical axis” should be understood as “relative to at least one axis from a group comprising a longitudinal axis, a transverse axis, and a vertical axis.”

In particular, the VTOL aircraft may have a computer that controls and/or regulates the cruising flight system and/or the hover flight system.

In particular, the lift element or one of the lift elements can be equipped to be bendable, pivotable, or deflectable such that it is configured to provide thrust for cruising flight.

In particular, the cruising flight system continues to have at least one propulsion element, in particular one specifically designed for this purpose, which is configured to provide thrust for cruising flight. In an embodiment without such a propulsion element, at most unpowered gliding flight is possible instead of cruising flight.

In particular, the longitudinal axis, transverse axis, and vertical axis pass through the center of mass of the VTOL aircraft.

In particular, the at least one stabilizing element is arranged in a plane which is spanned by the longitudinal axis and the vertical axis.

In particular, the at least one stabilizing element is pivotable and arranged such that a pivot axis of the stabilizing element is arranged in a plane which is spanned by the longitudinal axis and the vertical axis. Another pivot axis may be designed to be parallel to the transverse axis.

In particular, the at least one stabilizing element is located above the wing in an extended state, in particular such that no lift force can be generated by the stabilizing element, but only rolling moments and/or pitching moments.

In some embodiments, the lift element is configured such that a vector of the lift force is pivotable about the longitudinal axis, the transverse axis, and/or an axis parallel to the transverse axis.

In particular, the hover flight system may comprise a lift element arranged in a fuselage of the VTOL aircraft, which is configured to provide a lift force and is arranged such that the lift force acts at a center of mass of the VTOL aircraft.

In some embodiments, however, the hover flight system comprises two lift elements that are arranged in a fuselage of the VTOL aircraft, which are each configured to provide a lift force and are arranged such that one of the two lift forces acts in front of and the other acts behind a center of mass of the VTOL aircraft with respect to the longitudinal axis.

In further embodiments, the hover flight system comprises at least two lift elements that are arranged in a fuselage of the VTOL aircraft, which are each configured to provide a lift force. This is preferably in combination with at least two lift elements that are arranged laterally on the fuselage of the VTOL aircraft.

In another preferred embodiment, the hover flight system comprises 4-20, in particular 4-16, specifically 4-12 lift elements arranged in a fuselage of the VTOL aircraft.

In a particularly preferred embodiment, the hover flight system comprises exactly 4 or 12 lift elements arranged in a fuselage of the VTOL aircraft.

In particular, the 4-20 lift elements, which are arranged in a fuselage of the VTOL aircraft, are arranged such that at least two lift elements are arranged in front of and at least two behind a center of mass of the VTOL aircraft with respect to the longitudinal axis.

In particular, the 4-20 lift elements, which are arranged in a fuselage of the VTOL aircraft, are arranged such that 50% of the lift elements are arranged in front of and 50% behind a center of mass of the VTOL aircraft.

The at least two lift elements, which are arranged in the fuselage of the VTOL aircraft, and/or the at least two lift elements, which are arranged laterally on the fuselage of the VTOL aircraft, are arranged in particular such that at least one lift force acts in front of and at least one acts behind a center of mass of the VTOL aircraft with respect to the longitudinal axis.

This turns out to be practical for reasons of redundancy, among other things. In the event of technical malfunctions and/or bird strikes, for example, trouble-free operation or at least safe emergency operation can be ensured.

In particular, the lift elements are arranged in compartments in the fuselage that can be opened and closed by flaps and/or other covers. For cruising flight, in which lift is generated by the airfoil of the fixed wing, the flaps are closed and the fuselage has an aerodynamically favorable surface, whereas for hover flight the flaps remain open.

In particular, the flaps are also usable to deflect the air jets generated by the lift elements.

In some embodiments, the two lift elements or respective deflection elements of the lift elements, which are especially provided for this purpose, are pivotable such that the two lift forces generate a yawing moment that acts on the VTOL aircraft. In particular, this is achieved by a pivoting of the lift elements/deflection elements relative to the longitudinal axis in the opposite direction.

In particular, forces along the longitudinal axis and/or the transverse axis are achievable by the deflecting flaps, by the pivoting of the lift elements and/or by the pivoting of the deflection elements.

In some embodiments, the two lift elements are controllable such that a pitching moment can be provided by means of a thrust difference.

In particular, the two lift elements can also be configured to be pivotable about an axis parallel to the transverse axis such that a pitching moment is providable by means of a thrust direction difference.

In some embodiments, the at least one stabilizing element, in particular and the at least one lift element, is configured to be stowable in a fuselage of the VTOL aircraft and extendable from the fuselage.

In particular, the compartment in which the stabilizing element is retracted can also be closeable by flaps such that the fuselage has an aerodynamically optimized surface. The flaps can remain open while the stabilizing element is in use.

In some embodiments, the hover flight system comprises a lever device which is pivotably mounted within the fuselage at a first end and at whose second end the at least one stabilizing element is arranged.

In particular, the lever device is configured as a linkage or framework.

In a further preferred embodiment, the lever device is foldable.

In particular, the lever device has at least one joint. Preferably, the joint is arranged at half the length of the lever device when the lever device is in an unfolded state.

This has the advantage that a longer lever arm can be provided. A greater rolling and/or pitching moment can be generated thereby.

In some embodiments, the hover flight system has an extension device which is fixed at a first end within the fuselage and whose second end, on which the at least one stabilizing element is arranged, is configured to extend telescopically out of the fuselage.

In particular, the lever device or the extension device (as well as the stabilizing element) is insertable into and removable from said compartment in the fuselage.

In some embodiments, the stabilizing element is mounted at the second end to be pivotable about at least one axis such that the stabilizing force generates at least one rolling moment that acts on the VTOL aircraft.

In particular, the stabilizing element is mounted at the second end to be pivotable about an axis parallel to the longitudinal axis.

In some embodiments, the hover flight system is configured to pivot the lever device or the extension device.

In particular, a pivot axis for this pivotability is arranged within the fuselage and parallel to the transverse axis.

In particular, this pivotability can be used to stow and extend the lever device or extension device, or also for stabilization of the hover flight.

In some embodiments, the hover flight system comprises at least two stabilizing elements that are arranged one behind the other with respect to the longitudinal axis.

In particular, these two stabilizing elements can be arranged on a single lever device or extension device or on respective separate lever devices or extension devices which are stowable in separate compartments in the fuselage, in particular one stabilizing element in front of the center of mass and one behind the center of mass (with respect to the longitudinal axis), in particular one stabilizing element in front of a cockpit and one behind the cockpit (with respect to the longitudinal axis).

In summary, stabilizing elements are thus provided that are easy to manufacture, are flexible and require few resources for production and only minimal maintenance.

In some embodiments, the stabilizing element comprises a motorized propeller, folding propeller, rotor, ducted fan, impeller and/or a turbine jet engine (e.g. jet engine with/without bypass flow, propfan engine).

In particular, the lift element and/or the propulsion element are also configured as a motorized propeller, folding propeller, rotor, ducted fan, impeller or turbine jet engine (jet engine with/without bypass flow, propfan engine).

In some embodiments, the stabilizing element and/or lift element are configured for cyclical and/or collective blade adjustment.

In particular, moments on the transverse axis or the longitudinal axis can be generated by the cyclical and/or collective blade adjustment without the stabilizing element being configured to be pivotable relative to the lever device or the extension device.

In some embodiments, the hover flight system is configured to control a rotational speed and a pivot angle (and thus the thrust vector) of the stabilizing element.

In particular, the pivot angle of the stabilizing element can be controlled by at least one servomotor.

In particular, the aforementioned computer is configured for this control and is connected in an appropriate manner to the at least one stabilizing element.

In particular, the lift element and/or the propulsion element can also be regulated/controlled by the computer.

In a preferred embodiment, the lift elements and/or the propulsion element can be regulated/controlled by the computer such that each individual lift element and/or propulsion element can be controlled individually.

In particular, the lift elements and/or the propulsion element can be controlled by the computer such that the lift elements and/or the propulsion element are pivotable independently of each other about the transverse axis, about an axis parallel to the transverse axis, about the vertical axis, about an axis parallel to the vertical axis, about the longitudinal axis and/or about an axis parallel to the longitudinal axis.

Flexible control of the individual lift elements and/or the propulsion element is ensured thereby, so that an adjustment of the lift and/or propulsion forces, which is as efficient as possible, is possible.

In some embodiments, the stabilizing element is configured as a multicopter. The pivot angle of the multicopter can be controlled in the multicopter by at least one servomotor or by the thrust difference of the individual drives of the multicopter. Due to the aerodynamic, i.e., elongated and narrow design of the fuselage, an arrangement of the individual drives of the multicopter, relative to its longitudinal axis, in two rows with two or more drives on each side of the longitudinal axis can be achieved.

In particular, the multicopter can be connected to the lever device or the extension device via a joint, in particular via a hinge joint or a cardan joint.

Particularly preferred, the multicopter is pivotably connected at its center of gravity to the lever device and/or the extension device.

In particular, the hover flight system may have a lift element, which also has the properties of the stabilizing element, and a stabilizing element which also has the properties of the lift element. This results in two identical elements which are configured in particular as motorized propellers, folding propellers, rotors, ducted fans, impellers, turbine jet engines (jet engine propulsion with/without bypass flow, propfan engine) and provide both lift and hover flight stabilization.

In particular, the lift element, propulsion element and/or stabilizing element are optionally an electric motor and/or a combustion engine.

In other words, the invention facilitates a modern aerodynamic design of the wings and fuselage, in particular the choice of modern thin airfoils without aerodynamically disruptive attachments such as booms having motors and propellers that are suspended in the air stream.

In particular, at least one thrust device with thrust mainly parallel to the vertical axis (impeller, propeller, ducted fan, jet turbines, etc.) is each installed in the longitudinal axis of the fuselage in front of and behind the center of gravity at a specified distance from the center of gravity.

In particular, the two aforementioned thrust devices can be pivoted in parallel or in opposite directions with respect to the longitudinal axis. Similarly, the two aforementioned thrust devices can be designed to be pivotable in parallel with respect to the transverse axis.

Instead of or in combination with the aforementioned pivotable embodiments, the thrust of the aforementioned thrust devices can also be deflected partially to the side and/or forwards or rearwards by means of flaps, lamellae, etc.

The two thrust devices according to the above embodiments facilitate translations along the vertical axis (vertically upward and downward movement or hovering), the longitudinal axis (forward or rearward hovering) and the transverse axis (hovering to one side or the other) as well as yawing about the vertical axis.

If the thrust of the aforementioned thrust devices is diverted by pivoting or by means of flaps, lamellae, etc. for control purposes, the aforementioned translational movements are possible without pitching or rolling movement of the aircraft.

Without vector control of the thrust, i.e. with thrust always parallel to the vertical axis, the translational movement along the longitudinal axis (hovering forwards or rearwards) would be possible due to pitching movement. The pitching movement is achieved by the thrust difference between the two aforementioned thrust devices. Similarly, without vector control of the thrust, i.e. with thrust always parallel to the vertical axis, translational movement along the transverse axis (hovering to one side or the other) would be possible by rolling movement. The at least one stabilizing element, which may also be designed as a lift element, is used to control and stabilize the rolling movement.

Preferably, to control the rolling movement, it is recommended to use at least one thrust device relative to the transverse axis (thrust to each side) on at least one boom in the plane formed by the longitudinal and vertical axes. The thrust parallel to the transverse axis (towards one side or the other) at a certain distance from the center of gravity can be achieved by means of a bearing arrangement of the thrust devices that is pivotable parallel to the longitudinal axis, by deflecting the thrust or by means of separate thrust devices for each side and/or by means of variable positive or negative pitch.

Preferably, the aforementioned device for controlling the rolling movement (boom having a separate thrust device) for cruising flight and, insofar as ailerons are available for controlling the rolling movement, can be retracted or pivoted into a receiving chamber or receiving chambers in the fuselage by means of a pivoting movement.

For cruising flight (lift of the wings), either a separate thrust device with thrust in the longitudinal direction or a pivoting of the thrust devices required for hover flight can be used. Optionally, a separate elevator or aileron can be omitted by controlling the aforementioned thrust vector.

The fuselage, which is as streamlined as possible, and more voluminous compared to the wings, is suitable for housing the thrust devices. The voluminous fuselage is suitable for accommodating the necessary support structures and for absorbing the thrust, transverse and torsional forces of the thrust devices.

Space for the cockpit, passengers and/or cargo is available, for example, in the vicinity of the center of gravity.

Preferably, the boom having a thrust device for controlling and governing at least the roll axis for cruising flight and for reducing air resistance can be pivoted into a receiving chamber in the fuselage. The front and rear thrust devices in the fuselage can be closed by the flaps for cruising flight, provided that a separate thrust device provides the thrust for cruising flight.

Due to the airflow during cruising flight, lift is provided by the wings and the control of the rolling movement about the longitudinal axis by the ailerons.

The boom having a separate thrust device is preferably used alone to control and govern the rolling movement. It can therefore be dimensioned much smaller than if the boom having a thrust device also had to provide the lift for hover flight. As a relatively small component, it can therefore be attached to a simple boom or beam in a pivotable or telescopically retractable manner without any disadvantages.

Thus, the wings need not accommodate separate thrust devices and can be designed to be aerodynamically optimal and low resistance for cruising flight.

In a further preferred embodiment, the hover flight system comprises at least two lift elements arranged laterally on the fuselage of the VTOL aircraft, which are each configured to provide a lift force.

This allows the roll axis to be additionally stabilized and/or controlled in the event of a rolling movement. In addition, this design turns out to be practical for redundancy reasons. In the event of technical malfunctions and/or bird strikes, for example, trouble-free operation can thus be ensured.

In particular, the at least two lift elements are arranged on opposite longitudinal sides of the fuselage.

The longitudinal sides of the fuselage are understood to be the sides of the fuselage that extend parallel to the longitudinal axis.

In a particularly preferred embodiment, the at least two lift elements are arranged along the transverse axis and/or along an axis parallel to the transverse axis.

In particular, the at least two lift elements, which are arranged laterally on the fuselage of the VTOL aircraft, can be configured to be bendable, pivotable or deflectable such that they are capable of providing thrust for cruising flight.

In some embodiments, the at least two lift elements, which are arranged laterally on the fuselage of the VTOL aircraft, are arranged such that, in hover flight and/or cruising flight, they are pivotable about the transverse axis, about an axis parallel to the transverse axis, about the vertical axis, about an axis parallel to the vertical axis, about the longitudinal axis, and/or about an axis parallel to the longitudinal axis.

In particular, the at least two lift elements are mounted to be pivotable about an axis parallel to the longitudinal axis, in particular such that translational movements to the side and/or yawing moments can be generated during hover flight.

In a further particular embodiment, the at least two lift elements are mounted to be pivotable about an axis parallel to the transverse axis, in particular such that translational movements forward, translational movements rearward, pitching moments and/or yawing moments can be generated during hover flight.

Preferably, the at least two lift elements are mounted to be continuously pivotable about an axis each parallel to the transverse axis, in particular so that they can provide thrust for cruising flight.

In another embodiment, the at least two lift elements, which are arranged laterally on the fuselage of the VTOL aircraft, are each pivotable by at least 90 degrees, in particular by at least 180 degrees.

In particular, the at least two lift elements, which are arranged laterally on the fuselage of the VTOL aircraft, are pivotable by 360 degrees about the transverse axis and/or about an axis parallel to the transverse axis.

In a particular embodiment, the at least two lift elements, which are arranged laterally on the fuselage of the VTOL aircraft, provide a lift force and/or a thrust for cruising flight.

This ensures flexibility in the flight direction, as either a hover flight, i.e. a vertical movement, a cruising flight, i.e. a horizontal movement, or a combination of these is possible.

This also makes it possible to generate yawing, pitching and/or rolling moments during hover flight and/or cruising flight.

In particular, the at least two lift elements, in particular all lift elements, are arranged such that they are spaced from the longitudinal axis at a maximum of 50%, in particular at a maximum of 30%, and particularly preferred at a maximum of 20% of the total length of half the wingspan of the wing.

An advantageous distribution of mass close to the fuselage or center of gravity is achieved thereby, which leads to less inertia of the overall system.

A distance between a point on the longitudinal axis and a wing tip is meant by half the wingspan of the wing, wherein the distance is perpendicular to the longitudinal axis. The respective end of a wing is meant by a wing tip.

In a further preferred embodiment, the hover flight system comprises two lift elements arranged in the fuselage of the VTOL aircraft and at least two lift elements arranged laterally on the fuselage of the VTOL aircraft.

In particular, the hover flight system comprises at least two lift elements arranged in the fuselage of the VTOL aircraft and at least two lift elements arranged laterally on the fuselage of the VTOL aircraft.

In particular, no lift elements are arranged on and/or within the wing.

In a further preferred embodiment, no stabilizing elements are arranged on and/or within the wing.

### BRIEF DESCRIPTION OF THE DRAWINGS

Further advantages of the present invention are apparent from the detailed description and the drawings.

FIG. 1 is a side view of a VTOL aircraft according to a first exemplary embodiment of the present invention, wherein the stabilizing elements for hover flight are extended;

FIG. 2 shows a front view of the VTOL aircraft from FIG. 1;

FIG. 3 shows a top view of the VTOL aircraft from FIGS. 1 and 2;

FIG. 4 shows a side view of the VTOL aircraft from FIGS. 1 to 3, wherein the stabilizing elements for cruising flight are retracted;

FIG. 5 shows a side view of a VTOL aircraft according to a second embodiment of the present invention, wherein the stabilizing and lift elements for hover flight are extended; and

FIG. 6 shows a top view of the VTOL aircraft from FIG. 5.

### WAYS OF CARRYING OUT THE INVENTION

FIG. 1 is a side view of a VTOL aircraft 1 according to a first exemplary embodiment of the present invention, wherein the stabilizing elements 5 and 6 are extended for hover flight. The stabilizing elements 5 and 6 are designed here as propellers and are mounted in a motorized rotatable manner at a first end of the lever device 9, which is designed as a framework. The two propellers 5 and 6 are also pivotable about an axis parallel to the longitudinal axis L. This pivotability is indicated in FIGS. 1 to 3 by the indicated positions of the propellers. The axes L, Q and H pass through the center of mass M of the aircraft 1. The aircraft 1 has a cockpit 23.

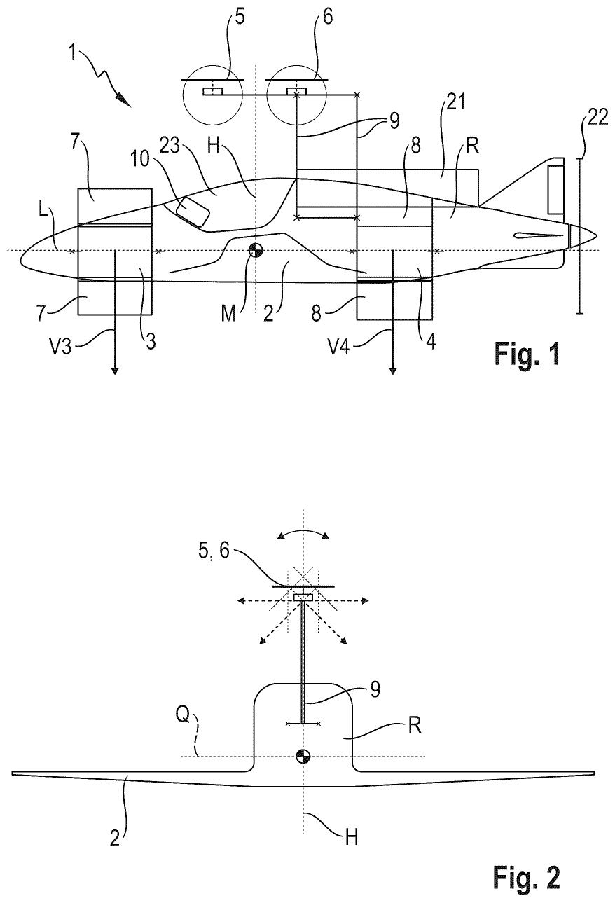

The framework 9 is a double linkage that can fold up like a parallelogram. The two propellers 5 and 6 are equidistant from the vertical axis H. The lift elements 3 and 4 are located in the fuselage R of the VTOL aircraft 1 and their force vectors V3 and V4 always act on the longitudinal axis L, despite the pivotability. The generation of rolling moments by the lift elements 3 and 4 is therefore not possible. A main task of the stabilizing elements 5 and 6 is therefore to generate compensating rolling moments for stable hover flight. For this purpose, the propellers 5 and 6 can pivot to the left or right at an angle between 0 and 90 degrees as required (see FIG. 2) and the speed can be varied. At least one servo motor controls the angle of rotation to the left and right. The lever device can be extended into or retracted from the fuselage by a servo motor. Alternatively or in combination, the lever device can be extended using the thrust drive of the stabilizing element and retracted by gravity. In particular, a computer 10 is configured to execute the necessary control and regulation tasks.

Said pivotability of the lift elements 3 and 4 is provided about the longitudinal axis L and about an axis parallel to the transverse axis Q. Translational movements along the longitudinal axis L and the transverse axis Q are possible thereby. The lift elements 3 and 4 are fixedly inset in the fuselage R and the air flow can enter and escape through the flaps 7 and 8. In the present example, the lift elements 3 and 4 are impellers and/or turbines.

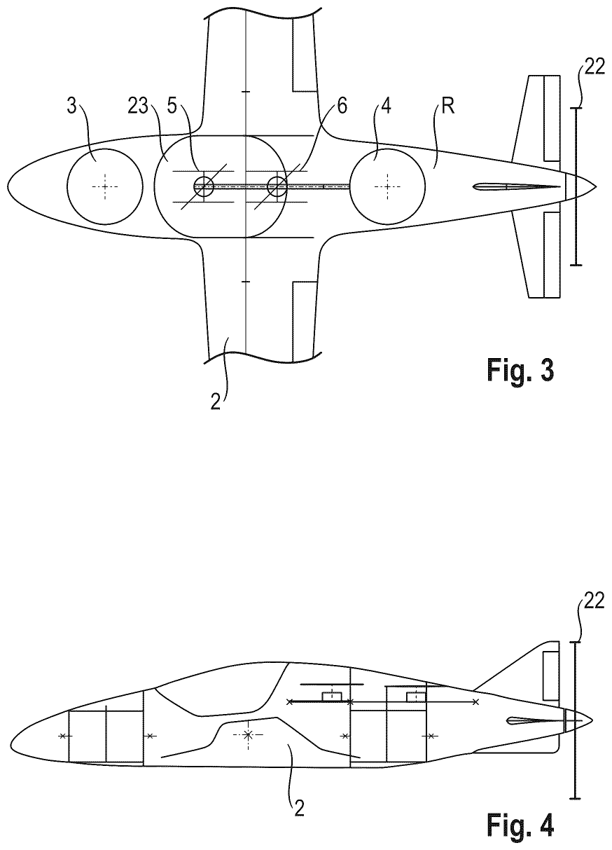

The compartment in which the stabilizing elements 5 and 6 are stowed inside the fuselage R (see FIG. 4) is also closed with flaps 21 (see FIG. 1). For simplicity, the flaps are not shown in FIGS. 2 and 3. Thus, the aircraft 1 is aerodynamically optimized for cruising flight. For this purpose, the aircraft 1 also has a propulsion element 22, which is designed here as a propeller.

FIG. 2 shows a front view of the VTOL aircraft 1 from FIG. 1. The wing 2 is used for subsequent cruising flight, which is initiated with a transition from hover flight. The linkage 9 is not substantially pronounced along the transverse axis Q, so that among other things a good stowability in the fuselage R is ensured. The pivotability of the stabilizing elements 5 and 6 in four additional different directions is indicated by the curved arrow and the dashed lines of the propellers. The dashed vector arrows corresponding to these different directions indicate the stabilizing forces generated in each case. In the illustrated initial position, the propellers 5 and 6 are aligned horizontally and rotate only when idling, for example. As soon as there is a need to compensate for an unwanted rolling movement, the stabilizing elements 5, 6 are pivoted to the respective side and generate the required thrust. A very fast responsiveness can be achieved with the pivoting, also due to the comparatively low masses to be moved and the small inertia.

FIG. 3 shows a top view of the VTOL aircraft 1 from FIGS. 1 and 2. The lift elements 3 and 4, which are accommodated centrally in the fuselage R, can be seen. The extended stabilizing elements 5 and 6 are located above the cockpit 23 for the duration of the hover flight and during transitions from/to cruising flight. During these times, pitching and yawing moments are generated (primarily) by the lift elements 3 and 4, while rolling moments are generated by the stabilizing elements 5 and 6. A stable hover flight is thereby ensured without resorting to heavy, complex elements that are unfavorably distributed in terms of inertia. The construction according to the invention saves weight in particular, which is a very important criterion for vertical take-off.

FIG. 4 shows a side view of the VTOL aircraft from FIGS. 1 to 3, wherein the stabilizing elements 5, 6 are retracted for cruising flight. The lift is now generated solely by the wing 2.

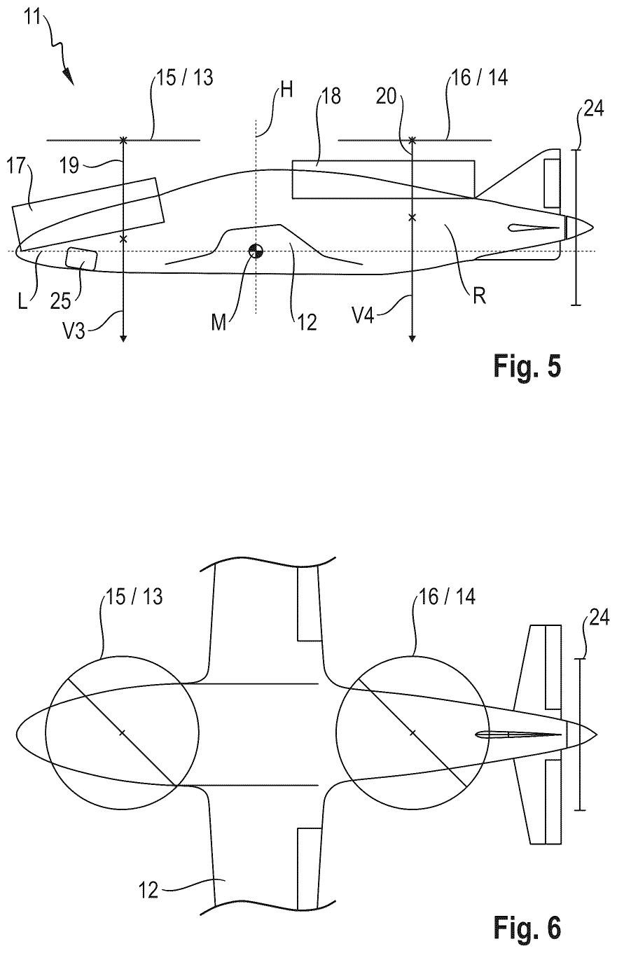

FIG. 5 shows a side view of an unmanned VTOL aircraft 11 according to a second embodiment of the present invention, wherein the stabilizing and lift elements 13/15, 14/16 are extended for hover flight. The stabilizing element 15 of the aircraft 11 is also configured as a lift element 13, in that the flap propeller or rotor is dimensioned significantly larger. The propeller blades are designed to be foldable so that they can be positioned parallel to the booms and take up less storage space. The lift element 14 is also configured as a stabilizing element 16 in that, like the stabilizing element 15, it is pivotable about an axis parallel to the longitudinal axis L. In the illustrated example, the pivot point for the pivotability is located in the rotor plane (marked as a cross in the drawing). Thus, yawing, pitching and rolling moments can be provided by the two propellers. The lower crosses mark the pivot axis of the lever devices 19, 20 for stowage in the fuselage R. The lift is possible in a largely unimpeded manner because the air flow can stream past the fuselage R. Here, the lift vectors V3 and V4 extend through the pivot axis of the stabilizing and lift elements, which is parallel to the longitudinal axis L.

FIG. 6 shows a top view of the VTOL aircraft 11 from FIG. 5. In a transition to cruising flight, the propulsion element 24 is activated and a translational velocity along the longitudinal axis L is built up. The lift/stabilizing elements 15/13 and 16/14 are brought to a standstill, retract into the fuselage R and the flaps 17 and 18 close.

The lever devices 19, 20 are therefore mounted within the fuselage to be pivotable. This pivotability, as well as the pivotability of the propellers, is provided by a servomotor and controlled/regulated by computer 25.

Although the invention has been explained with reference to its preferred embodiment(s), many further modifications and variations may be made without departing from the scope of the present invention. It is therefore intended that the accompanying claims cover such modifications and variations included within the scope of the invention.

### REFERENCE NUMBER LIST

| | |
|---|---|
| 1, 11 | VTOL aircraft |
| 2, 12 | Wing |
| 3, 13 | Lift element |
| 4, 14 | Lift element |
| 5, 15 | Stabilizing element |
| 6, 16 | Stabilizing element |
| 7, 17 | Flaps/Deflection elements |
| 8, 18 | Flaps/Deflection elements |
| 9, 19, 20 | Lever device |
| 10, 25 | Computer |
| 21 | Flaps |
| 22, 24 | Propulsion element |
| 23 | Cockpit |
| H | Vertical axis |
| L | Longitudinal axis |
| M | Centre of mass |
| Q | Transverse axis |
| R | Fuselage |
| V3 | Vector of the lift force |
| V4 | Vector of the lift force |

1. A VTOL aircraft comprising:
a cruising flight system comprising at least one wing that is configured to generate dynamic lift during cruising flight, and
a hover flight system comprising at least one lift element and at least one stabilizing element,
wherein:
the lift element is configured to generate a lift force for hover flight and
the stabilizing element is configured to generate, using a lever, at least one stabilizing force relative to a longitudinal axis, to a transverse axis and/or to a vertical axis of the VTOL aircraft during hover flight as well as during a transition from hover flight to cruising flight and during a transition from cruising flight to hover flight.

2. The VTOL aircraft according to claim 1, wherein the lift element is configured such that a vector of the lift force is pivotable about the longitudinal axis, about the transverse axis and/or about an axis parallel to the transverse axis.

3. The VTOL aircraft according to claim 1, wherein:
the hover flight system comprises two lift elements that are disposed in a fuselage of the VTOL aircraft,
each of the two lift elements is configured to generate a lift force, and
the two lift elements are arranged such that the lift force of one of the two lift elements acts in front of a center of mass of the VTOL aircraft along the longitudinal axis and the lift force of the other of the two lift elements acts rearward of the center of mass of the VTOL aircraft along the longitudinal axis.

4. The VTOL aircraft according to claim 3, wherein the two lift elements or respective deflection elements of the lift elements are pivotable such that the two lift forces generate a yawing moment that acts on the VTOL aircraft.

5. The VTOL aircraft according to claim 3, wherein the two lift elements are controllable such that a pitching moment is generated by operating the two lift elements to respectively generate different amounts of thrust.

6. The VTOL aircraft according to claim 1, wherein the at least one stabilizing element is configured to be stowable in a fuselage (R) of the VTOL aircraft and to be extendable from the fuselage.

7. The VTOL aircraft according to claim 6, wherein the hover flight system further comprises:
a lever device having a first end that is pivotably mounted within the fuselage and a second end on which the at least one stabilizing element is disposed, or
an extension device having a first end that is fixed within the fuselage and a second end, on which the at least one stabilizing element is disposed, the extension device being configured to extend telescopically out of the fuselage.

8. (canceled)

9. The VTOL aircraft according to claim 7, wherein the stabilizing element is mounted at the second end of the lever device or the extension device and is pivotable about at least one axis selected from the longitudinal axis, the transverse axis and the vertical axis such that the stabilizing force generates at least one rolling moment that acts on the VTOL aircraft.

10. The VTOL aircraft according to claim 7, wherein the hover flight system is configured to pivot the lever device or the extension device.

11. The VTOL aircraft according to claim 1, wherein the hover flight system comprises at least two stabilizing elements arranged one behind the other along the longitudinal axis.

12. The VTOL aircraft according to claim 1, wherein the stabilizing element comprises a motorized propeller, a folding propeller, a rotor, a ducted fan, an impeller and/or a turbine jet engine.

13.-14. (canceled)

15. The VTOL aircraft according to claim 7, wherein the stabilizing element is configured as a multicopter.

16. The VTOL aircraft according to claim 15, wherein the multicopter is pivotably connected to the lever device and/or the extension device at its center of gravity.

17. The VTOL aircraft according to claim 1, wherein the hover flight system comprises at least two lift elements that are arranged laterally on the fuselage of the VTOL aircraft and are each configured to generate a lift force.

18.-24. (canceled)

25. The VTOL aircraft according to claim 1, wherein no lift elements are disposed on and/or within the wing.

26. The VTOL aircraft according to claim 1, wherein no stabilizing elements are disposed on and/or within the wing.

27. The VTOL aircraft according to claim 1, wherein the at least one stabilizing element is arranged in a plane which is spanned by the longitudinal axis and the vertical axis.

28. The VTOL aircraft according to claim 1, wherein:
a) the at least one stabilizing element is disposed in a plane which is spanned by the longitudinal axis and the vertical axis;
b) the at least one stabilizing element is configured to be stowable in a fuselage of the VTOL aircraft and to be extendable from the fuselage;
c) the hover flight system comprises a lever device having a first end that is pivotably mounted within the fuselage; and
d) the stabilizing element is mounted at a second end of the lever device and is pivotable about at least one axis selected from the longitudinal axis, the transverse axis and the vertical axis such that the stabilizing force generates at least one rolling moment that acts on the VTOL aircraft.

29. The VTOL aircraft according to claim 1, wherein:
a) the at least one stabilizing element is disposed in a plane which is spanned by the longitudinal axis and the vertical axis; and
b) the hover flight system comprises two lift elements that are disposed in a fuselage of the VTOL aircraft, each of the two lift elements is configured to generate a lift force, and the two lift elements are arranged such that the lift force of one of the two lift elements acts in front of a center of mass of the VTOL aircraft along the longitudinal axis and the lift force of the other of the two lift elements acts rearward of the center of mass of the VTOL aircraft along the longitudinal axis.

30. The VTOL aircraft according to claim 1, wherein:
a) the at least one stabilizing element is disposed in a plane which is spanned by the longitudinal axis and the vertical axis;
b) the at least one stabilizing element is located in an extended state above the wing;
c) the at least one stabilizing is configured to be stowable in a fuselage of the VTOL aircraft and to be extendable from the fuselage;
d) the hover flight system comprises a lever device having a first end that is pivotably mounted within the fuselage; and
e) the stabilizing element is mounted at a second end of the lever device and is pivotable about at least one axis selected from the longitudinal axis, the transverse axis and the vertical axis such that the stabilizing force generates at least one rolling moment that acts on the VTOL aircraft.
